(19) United States
(12) Patent Application Publication
(10) Pub. No.: US 2025/0352002 A1
(43) Pub. Date: Nov. 20, 2025

(54) POWER TAKE OFF PASTA EXTRUDER ATTACHMENT FOR A STAND MIXER APPLIANCE

(71) Applicant: Haier US Appliance Solutions, Inc., Wilmington, DE (US)

(72) Inventors: Emily Rose Ashburn, Louisville, KY (US); Tomas Garces, Louisville, KY (US)

(21) Appl. No.: 18/669,082

(22) Filed: May 20, 2024

(51) Int. Cl. A47J 43/07; A21C 11/16; A47J 43/044

(52) U.S. Cl. CPC A47J 43/0711; A21C 11/16; A47J 43/044; A47J 2043/0449

(57) ABSTRACT

A pasta extruder attachment for a stand mixer includes a casing defining a funnel and a tube. A transmission is positioned at a distal end of the tube. The transmission is mechanically couplable to the stand mixer. A first shaft is coupled to the transmission and extends from the distal end of the tube to a proximal end of the tube. A second shaft coupled to the transmission and extends from the distal end of the tube to the proximal end of the tube. The second shaft is independently rotatable around the first shaft. An extruder block is couplable to the proximal end of the tube. A cutter is coupled to the first shaft at the proximal surface of the extruder block. The cutter is rotatable by the first shaft.

### FIELD OF THE INVENTION

The present subject matter relates generally to stand mixer appliances, and specifically to systems for extruding pasta with stand mixer appliance.

### BACKGROUND OF THE INVENTION

Stand mixers are generally used for performing mixing, churning, or kneading involved in food preparation. Typically, stand mixers include a motor configured to provide torque to one or more driveshafts. Users may connect various utensils to the one or more driveshafts, including whisks, spatulas, or the like. Making pasta noodles with a stand mixer may generally include a user feeding pasta dough into an extruding device and manually cutting each piece of pasta to the desired length. This process may be tedious and tiring, especially if a large amount of pasta is being made. Additionally, the user may present at the stand mixer for the whole duration of pasta making, meaning that the other preparations may have to wait.

Accordingly, a stand mixer with an improved pasta extruder for automatically extruding and cutting pasta would be advantageous.

### BRIEF DESCRIPTION OF THE INVENTION

Aspects and advantages of the invention will be set forth in part in the following description, or may be apparent from the description, or may be learned through practice of the invention.

In one example embodiment, a stand mixer is provided. The stand mixer defines a vertical direction, a lateral direction, and a transverse direction. The vertical, lateral, and transverse directions are mutually perpendicular. The stand mixer includes a housing with a controller and a motor disposed within the housing. The stand mixer also includes a mixing shaft operably coupled to the motor. The stand mixer further includes a power take off at the housing. A pasta extruder attachment is coupled to the power take off of the housing. The pasta extruder attachment includes a casing defining a funnel and a tube. The funnel extends from the tube in the vertical direction. A transmission is positioned at a distal end of the tube. The transmission is mechanically couplable to the power take off. A first shaft is coupled to the transmission and extends from the distal end of the tube to a proximal end of the tube. A second shaft coupled to the transmission and extends from the distal end of the tube to the proximal end of the tube. The first shaft is positioned within the second shaft. The second shaft is independently rotatable around the first shaft. An extruder block is couplable to the proximal end of the tube. The extruder block defines a plurality of slots on a proximal surface. A cutter is coupled to the first shaft at the proximal surface of the extruder block. The cutter is rotatable by the first shaft.

In another example embodiment, a pasta extruder attachment for a stand mixer is provided. The stand mixer includes a controller. The pasta extruder attachment includes a casing defining a funnel and a tube. The funnel extends from the tube in the vertical direction. A transmission is positioned at a distal end of the tube. The transmission is mechanically couplable to the stand mixer. A first shaft is coupled to the transmission and extends from the distal end of the tube to a proximal end of the tube. A second shaft coupled to the transmission and extends from the distal end of the tube to the proximal end of the tube. The first shaft is positioned within the second shaft. The second shaft is independently rotatable around the first shaft. An extruder block is couplable to the proximal end of the tube. The extruder block defines a plurality of slots on a proximal surface. A cutter is coupled to the first shaft at the proximal surface of the extruder block. The cutter is rotatable by the first shaft.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side view of an example stand mixer with a bowl according to example embodiments of the present disclosure.

FIG. 2 provides a side view of the stand mixer with a mixing attachment according to example embodiments of the present disclosure.

FIG. 3 illustrates a side view an example embodiment of a pasta extruder attachment attached to the stand mixer of FIG. 1, in accordance with aspects of the present disclosure.

FIG. 4 illustrates a perspective view of the example embodiment of the pasta extruder attachment of FIG. 3 in accordance with aspects of the present disclosure.

FIG. 5 illustrates a perspective, section view of the pasta extruder attachment of FIG. 4 in accordance with aspects of the present disclosure.

FIG. 6 illustrates a perspective view of a proximal end of an example pasta extruder attachment in accordance with aspects of the present disclosure.

FIG. 7 illustrates a perspective view of a proximal end of another example pasta extruder attachment in accordance with aspects of the present disclosure.

FIG. 8 illustrates an example network according to aspects of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related.

The terms “coupled,” “fixed,” “attached to,” and the like refer to both direct coupling, fixing, or attaching, as well as indirect coupling, fixing, or attaching through one or more intermediate components or features, unless otherwise specified herein.

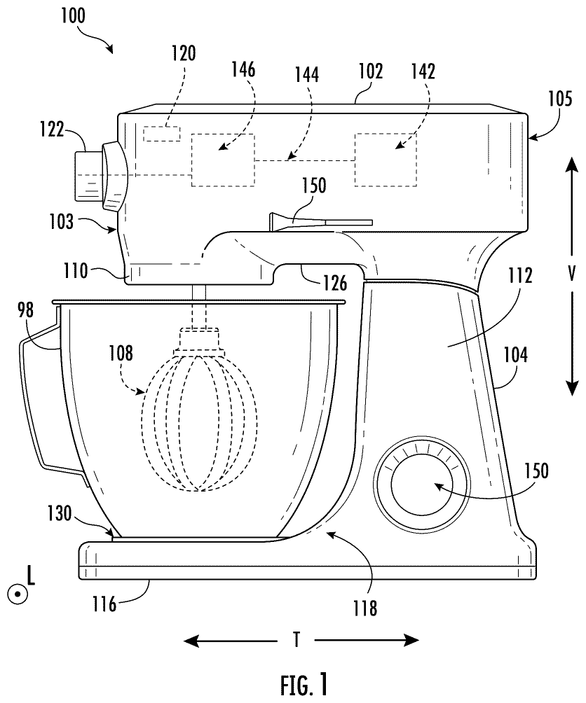

The present disclosure provides a mixer appliance with a secure mixing attachment coupling to a mixing shaft of the mixer appliance. This secure coupling may allow the mixer to rotate the shaft with the secured mixing attachment in clockwise and counterclockwise motions. The figures depict an example stand mixer appliance 100 that may be configured in accordance with various aspects of the present disclosure. It should be appreciated that the invention is not limited to any particular style, size, model, or shape for stand mixer appliance 100. The example embodiment in FIG. 1 is for illustrative purposes only. For example, appliance 100 may have different shapes and appearance for one or more parts, different motor and gear configurations, and other differences while remaining within the scope of the claimed subject matter.

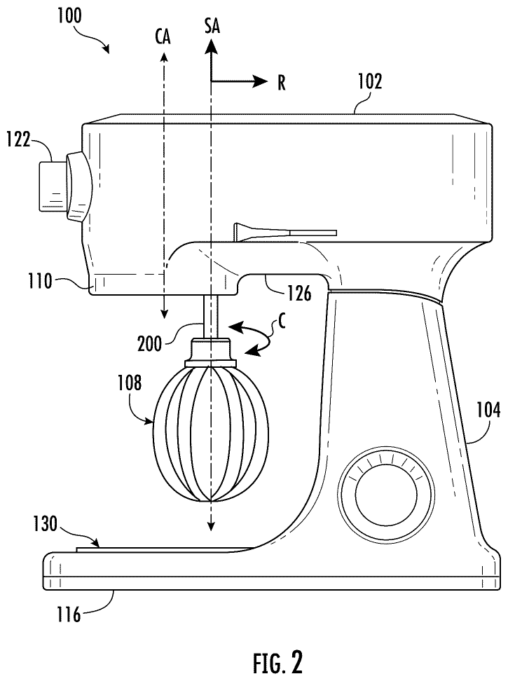

With reference for FIGS. 1 and 2, for the particular embodiment shown, a stand mixer appliance 100 includes a housing 102 and a base 104. Stand mixer 100 may extend between housing 102 and base 104 in a vertical direction V, across housing 102 in a lateral direction L, and from a front 103 to a back 105 in a transverse direction T. The vertical direction V, lateral direction L, and transverse direction T are perpendicular to one another.

Housing 102 may be pivotally mounted to base 104 and extends transversely between front 103 and back 105 of stand mixer appliance 100 when in the mixing position shown in FIG. 1. In some embodiments, housing 102 may be non-pivotably attached to base 104. Other configurations may be used where housing 102 may allow for access to a bowl 98 or to a removable mixing attachment 108, as otherwise understood. For this embodiment, base 104 includes upright support 112 and a horizontal base member 116. As shown, upright support 112 extends vertically from horizontal base member 116 and horizontal base member 116 extends transversely in front of upright support 112. Horizontal base member 116 may include a scale 130. In some embodiments, scale 130 may be concave, grooved, or otherwise shaped to accept bowl 98. Scale 130 may be generally configured to weigh bowl 98 and the contents therein.

Housing 102 includes an attachment support 110. A motor 142 is disposed within the housing 102. Attachment support 110 is located on a lower portion or underside 126 of housing 102 and forward of upright support 112 along transverse direction T. A mixing shaft 200 extends from attachment support 110. Removable mixing attachment 108 removably attaches to shaft 200.

Drivetrain 144 connects motor 142 with one or more gears 146 for causing rotation of attachment 108 or mixing shaft 200, e.g., mixing shaft 200 may be operably coupled to motor 142. Gears 146 may allow for selection by the user of different rotating speeds for attachment 108. In general, mixing attachment 108 may be coupled to shaft 200 prior to rotation of shaft 200 by motor 142. Furthermore, a power take off 122 may be positioned at housing 102, e.g., power take off 122 may extend from front 103 of housing 102. In general, power take off 122 may be mechanically coupled to drivetrain 144, ergo motor 142.

Stand mixer 100 may include one or more controls 150 for operations such as selectively powering motor 142, choosing the speed of rotation for attachments 108, locking position of housing 102 relative to base 104 during mixing, or other features. In some embodiments, controls 150 may include a rotational direction operation selection, allowing a user to select the direction of rotation of the mixing shaft 200.

In certain embodiments, attachment support 110 may accept more than one attachment 108. Various types of attachments 108 may be used including e.g., whisks, paddles, dough hooks, beaters, and others for purposes of mixing articles or mechanically manipulating articles within bowl 98 or other containers supported by base 104. During use, attachment support 110 with mixing shaft 200 may rotate attachment 108 in a circular or planetary fashion. Spinning in a planetary fashion, as used herein, includes spinning an object (e.g., shaft 200) about a first axis and revolving the object around a second axis, the object offset from the second axis. For example, shaft 200 may spin about a shaft axis SA, and revolve around a central axis CA, shaft 200 offset from central axis CA to generate spinning in a planetary rotation. Shaft axis SA may also be offset from central axis CA. In some embodiments, motor 142 may be disposed within base 104, including within upright support 112.

As shown in FIG. 2, mixing shaft 200 may rotate within attachment support 110. Mixing attachment 108 and mixing shaft 200 are rotatable by motor 142 in planetary rotation. Mixing shaft may define the shaft axis SA, with a radial direction R extending therefrom perpendicular to the shaft axis SA, and a circumferential direction C extending around the central axis CA. Mixing shaft 200 may rotate around central axis CA, wherein mixing shaft 200 is rotating in circumferential direction C. Additionally or alternatively, motor 142 may be operable to selectively rotate mixing attachment 108 in a clockwise direction or a counterclockwise direction in circumferential direction C around shaft axis SA. Thus, mixing shaft 200 may be reversible, or moveable in either direction during use. Attachment of mixing attachment 108 to shaft 200 allows for motion in both directions, clockwise and counterclockwise, by motor 142. In other words, motor 142 can rotate mixing attachment 108 and/or shaft 200 in a clockwise direction and can switch and rotate mixing attachment 108 and/or shaft 200 in a counterclockwise direction. Such movement may be directed by a user (e.g., by use of controls 150) or may be directed independent of a user, e.g., by using a timer, by using a controller, described hereinbelow, in operable communication with motor 142, or as otherwise understood.

In general, stand mixer 100 may include a controller 120. In particular, controller 120 may be located within housing 102. For instance, controller 120 may be a microcontroller, as would be understood, including one or more processing devices, memory devices, or controllers. Controller 120 may include a plurality of electrical components configured to permit operation of stand mixer 100 and various components therein (e.g., motor 142). For instance, controller 120 may include a printed circuit board (PCB) with various components coupled thereto, as would be understood by those of ordinary skill in the art.

As used herein, the terms “control board,” “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of stand mixer 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. According to still other example embodiments, controls 150 may include one or more microprocessors and/or one or more memory devices. Accordingly, certain components of stand mixer 100 may be controlled directly from controls 150. For example, controller 120 may be generally configured to perform a mixing cycle, whereby stand mixer 100 may be operated to mix food contents, such as food contents in bowl 98.

The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to a remote user interface (not shown) through any suitable network(s), such as through a high bandwidth local area network (LAN) or wide area network (WAN). In this regard, for example, controller 120 may further include a communication module or interface that may be used to communicate with one or more other component(s) of stand mixer 100, controller 120, an external appliance controller, an external device, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

As one skilled in the art will appreciate, the above described embodiments are used only for the purpose of explanation. Modifications and variations may be applied, other configurations may be used, and the resulting configurations may remain within the scope of the invention. For example, stand mixer 100 is provided by way of example only and aspects of the present subject matter may be incorporated into any other suitable stand mixer appliance.

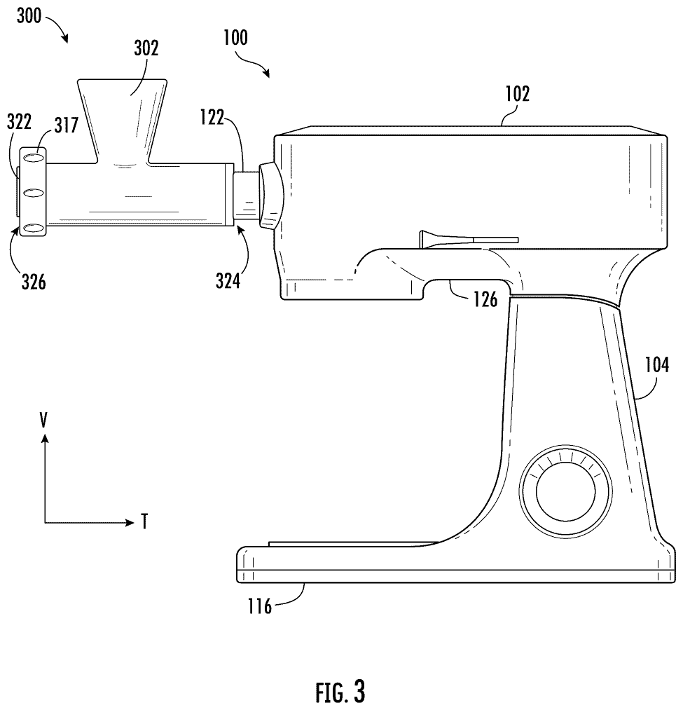

Turning now to FIG. 3, illustrated is an example embodiment of a pasta extruder attachment 300 coupled to the power take off 122 of housing 102. In general, pasta extruder attachment 300 may include a casing 302 extending between a distal end 324 and a proximal end 326 in the transverse direction T. For example, distal end 324 may be coupled with the power take off 122 of stand mixer 100. In general, pasta extruder attachment 300 may receive and push dough through the casing and extrude the dough into pasta out of the proximal end 326 of pasta extruder attachment 300. Further, a cutter 322 may be positioned at proximal end 326 for cutting extruded dough to a desired length, as will be further described hereinbelow.

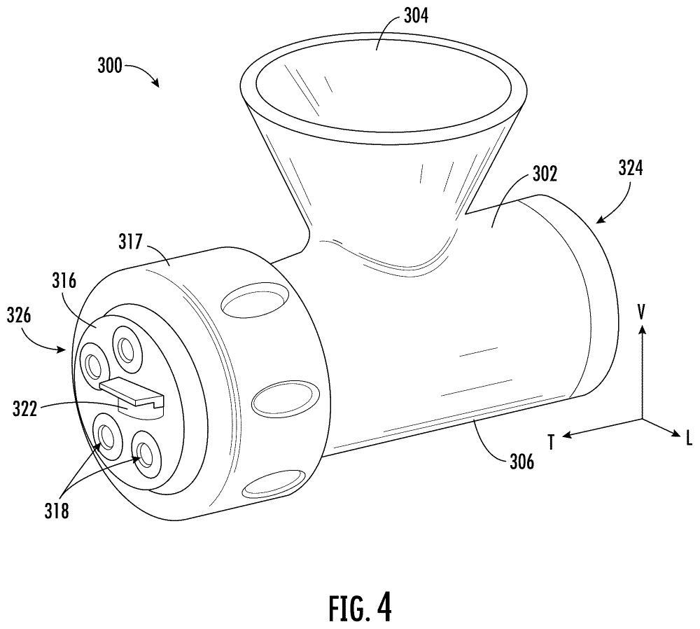

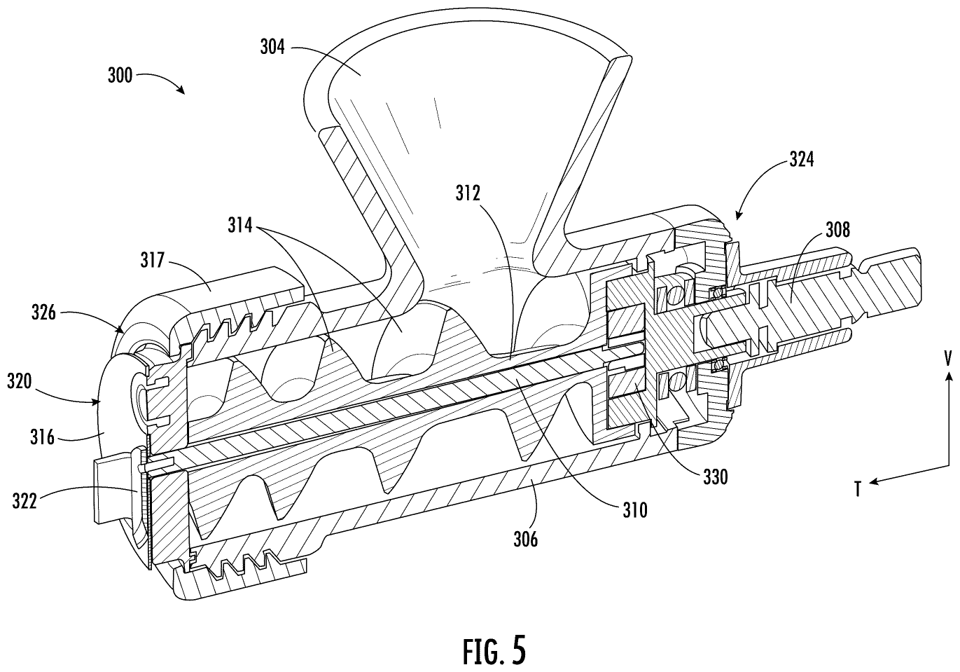

Turning now to FIGS. 4 and 5, provided are a perspective view of pasta extruder attachment 300 (FIG. 4), and a perspective, section view of pasta extruder attachment 300 (FIG. 5). Looking at FIG. 4, in general, casing 302 of pasta extruder attachment 300 may define a funnel 304 and a tube 306. Funnel 304 may generally extend from tube 306 in the vertical direction V, and form an opening for receiving dough, such as pasta dough or any other suitable dough. As such, dough may fall, via gravity, through funnel 304 in the vertical direction V into tube 306 to be extruded into pasta. Turning to FIG. 5, pasta extruder attachment 300 may generally include a transmission 308 positioned at the distal end 324 of tube 306. In general, transmission 308 may be mechanically coupled to power take off 122 of stand mixer 100 to transmit rotational motion to pasta extruder attachment 300. For example, transmission 308 may be any suitable transmission assembly, clutch mechanism, or other component configured to receive and transmit rotation from power take off 122 of stand mixer 100.

In general, a first shaft 310 and a second shaft 312 may be coupled to transmission 308. In particular, both first shaft 310 and second shaft 312 may generally extend from distal end 324 of tube 306 to proximal end 326 of tube 306. More specifically, first shaft 310 may extend to a proximal surface, as will be described in further detail hereinbelow. In general, first shaft 310 may be positioned inside of, or within, second shaft 312, e.g., such that first shaft 310 and second shaft 312 are concentric shafts. Furthermore, second shaft 312 may be independently rotatable around first shaft 310, such as via a one-way bearing 330. One-way bearing 330 may generally transmit torque/rotational energy to first shaft 310 and second shaft 312 when transmission 308 is rotating in one direction, e.g., mated, synchronous rotation of both first shaft 310 and second shaft 312, and one-way bearing 330 may transmit torque/rotational energy to only the second shaft 312 when rotating in the opposite direction, e.g., first shaft may not be driven by transmission 308.

Referring still to FIG. 5, second shaft 312 may generally include an auger, e.g., second shaft 312 may define a flighting 314 spiraling around second shaft 312. In particular, when rotating, flighting 314 may push dough from funnel 304 through tube 306 towards proximal end 326, where an extruder block 316 may be secured to tube 306 via a cap 317. In particular, cap 317 may be configured to screw onto tube 306 over extruder block 316, thereby securing extruder block 316 to proximal end 326 of tube 306. In general, extruder block 316 may be a modular insert including a plurality of slots 318 through a proximal surface 320 of extruder block 316. More specifically, the plurality of slots 318 may be shaped such that a desired style of pasta is extruded from extruder block 316, such as penne, rigatoni, spaghetti, fusilli, and tortiglioni, etc. In other words, extruder block 316 may be couplable to proximal end 326 of tube 306, and extruder block 316 may define slots for extruding a desired type of pasta.

In general, a cutter 322 may be positioned on proximal surface 320 of extruder block 316 and mechanically coupled to first shaft 310. In particular, cutter 322 may be any suitable shape to cut pasta away from extruder block 316, such as a blade or a wire, etc. Cutter 322 may generally be rotatable by first shaft 310, e.g., when transmission 308 is rotating in the direction such that one-way bearing 330 allows mated rotation of first shaft 310 and second shaft 312. Moreover, when rotating second shaft 312 to extrude pasta in one direction, such as the counterclockwise direction, motor 142 may change directions when the extruded pasta reaches a desired length (varies with types of pastas), and rotate in the clockwise direction, thereby rotating cutter 322 and cutting the extruded pasta from extruder block 316 at the desired length. Specifically, stand mixer 100 may rotate cutter 322 in at least one full rotation (360°) such that the extruded pasta is cut from each slot of the plurality of slots 318. As such, controller 120 may be configured to automatically control the direction of rotation of motor 142 in order to cut the pasta at the desired length, as will be further described hereinbelow.

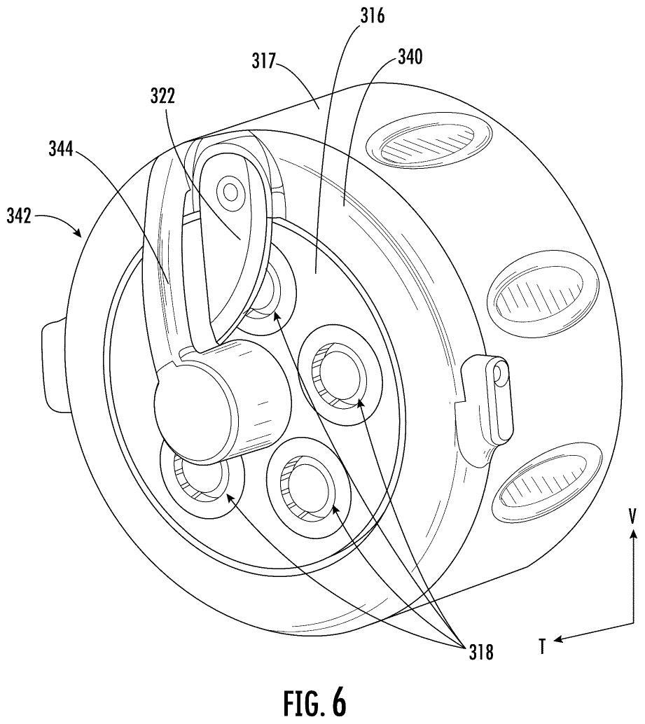

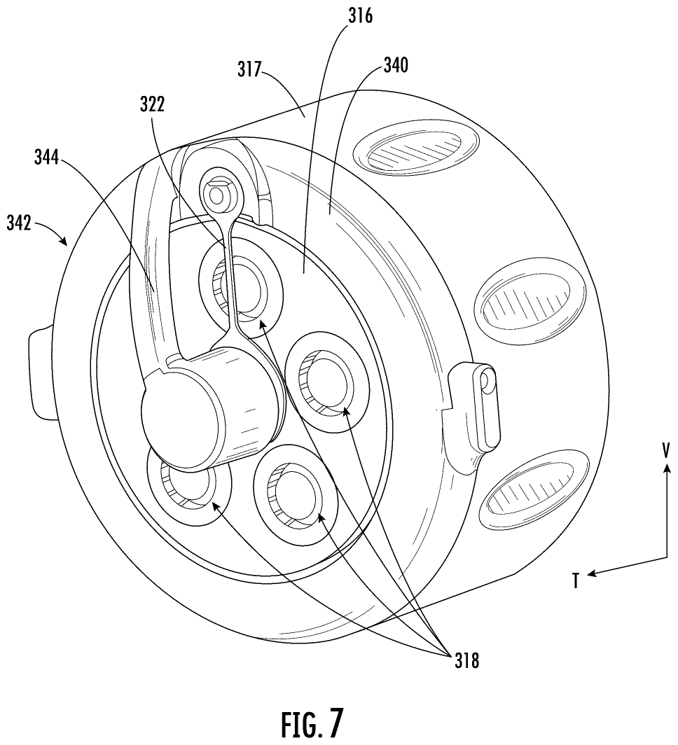

Turning now to FIGS. 6 and 7, perspective views of additional or alternative embodiments of components at the proximal end 326 of pasta extruder attachment 300 is provided. In the present example embodiment, pasta extruder attachment 300 may include an outer ring 340 positioned around extruder block 316, over top a front portion of cap 317. In general, outer ring 340 may be coupled to and rotatable by first shaft 310. In particular, outer ring 340 may include an arm 344 extending from the first shaft 310 at the proximal end 326 of tube 306 to an exterior edge 342 of the outer ring 340. In general, cutter 322 may be positioned on exterior edge 342 of outer ring 340, such that cutter 322 is indirectly coupled to first shaft 310 and may rotate with the rotation of outer ring 340. In particular, arm 344 may be coupled to first shaft 310 from exterior edge 342 of outer ring 340 in order to rotate outer ring 340 when transmission 308 is rotating in the direction such that one-way bearing 330 allows mated rotation of first shaft 310 and second shaft 312. As seen in FIGS. 6 and 7, cutter 322 may be any suitable shape to cut pasta away from extruder block 316, such as a blade (FIG. 6) or a wire (FIG. 7).

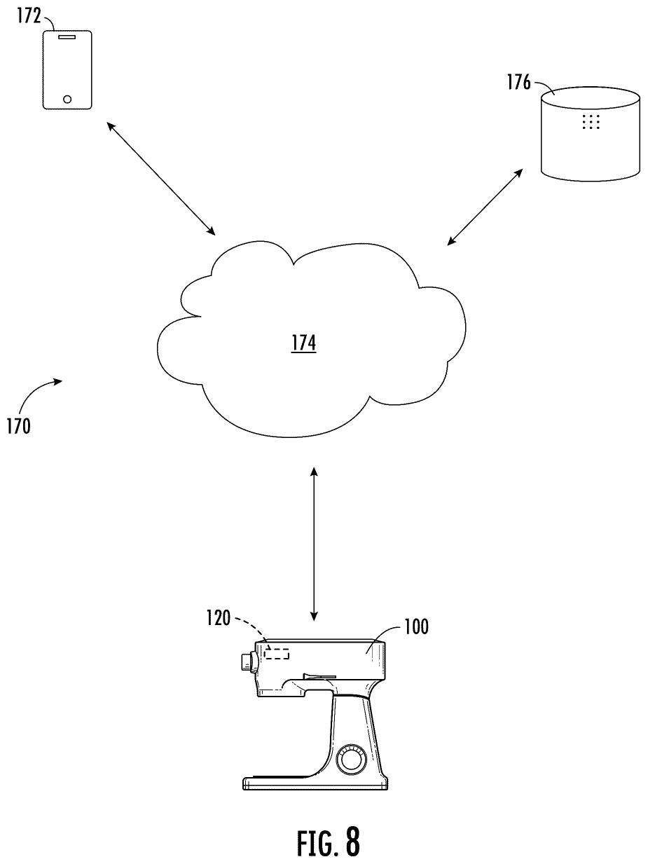

Turning to FIG. 8, controller 120 may be in wireless communication with an external device, such as one or more of a smartphone 172, referred to generally as external device 172, and/or a database 176, over a network 174. In particular, FIG. 8 illustrates a schematic diagram of an external communication system 170 which will be described according to an example embodiment of the present subject matter. In general, external communication system 170 is configured for permitting interaction, data transfer, and other communications between stand mixer 100 and one or more external devices. For example, this communication may be used to provide and receive operating parameters, user instructions or notifications, performance characteristics, user preferences, or any other suitable information for improved performance of stand mixer 100. In addition, it should be appreciated that external communication system 170 may be used to transfer data or other information to improve performance of one or more external devices or appliances and/or improve user interaction with such devices.

For example, external communication system 170 permits controller 120 of stand mixer 100 to communicate with a separate device external to stand mixer 100, such as external device 172 and/or database 176. These communications may be facilitated using a wired or wireless connection, such as via network 174. In general, external device 172 may be any suitable device separate from stand mixer 100 that is configured to provide and/or receive communications, information, data, or commands from a user. In this regard, external device 172 may be, for example, a personal phone, a smartphone, a tablet, a laptop or personal computer, a wearable device, or another mobile or remote device.

In addition, a remote server, or database 176 may be in communication with stand mixer 100 and/or external device 172 through network 174. In this regard, for example, database 176 may be a cloud-based server, and is thus located at a distant location, such as in a separate state, country, etc. According to an example embodiment, external device 172 may communicate with database 176 over network 174, such as the Internet, to transmit/receive data or information, provide user inputs, receive user notifications or instructions, interact with or control stand mixer 100, etc. In addition, external device 172 and database 176 may communicate with stand mixer 100 to communicate similar information.

In general, communication between stand mixer 100, external device 172, database 176, and/or other user devices or appliances may be carried using any type of wired or wireless connection and using any suitable type of communication network, non-limiting examples of which are provided below. For example, external device 172 may be in direct or indirect communication with stand mixer 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an example embodiment of the present subject matter. However, it should be appreciated that the example functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

For example, controller 120 may communicate with external device 172 and/or database 176 to determine a desired length for the pasta being extruded by stand mixer 100. In other words, a user may use a smartphone or any other suitable external device to set a desired pasta length, control (as in pause or stop) motor 142 of stand mixer 100, or set up timers for how long the stand mixer should operate. In particular, in one example scenario, a user may use a smartphone to set the cut length of pasta being extruded to two inches (2 in), whereby stand mixer 100 may automatically reverse the direction of rotation of motor 142 in order to cut the extruded pasta each instance where two inches (2 in) of pasta is extruded from the pasta extruder attachment 300. Furthermore, stand mixer 100 may measure a torque of transmission 308, such that controller 120 may identify when all dough is extruded and may stop motor 142.

As may be seen from the above, a stand mixer attachment that extrudes pasta is provided. The attachment includes a cutter to automatically regulate pasta length in order to automate a pasta making process. The stand mixer motor may rotate both clockwise and counterclockwise, where the pasta extruder attachment includes a one-way bearing allowing rotation in one direction and locking in the other direction. The rotation may be utilized to assign different actions to each direction, e.g., in the counterclockwise direction pasta is extruded, and in the clockwise direction the one-way bearing may engage to rotate the cutter and cut the extruded pasta. In addition, a user may use an external device to set a pasta length or set a timer to pause or stop the motor of the stand mixer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A stand mixer defining a vertical direction, a lateral direction, and a transverse direction, the vertical, lateral, and transverse directions being mutually perpendicular, the stand mixer comprising:
a housing;
a controller within the housing;
a motor disposed in the housing;
a mixing shaft operably coupled to the motor;
a power take off at the housing; and
a pasta extruder attachment coupled to the power take off of the housing, the pasta extruder attachment comprising:
a casing defining a funnel and a tube, the funnel extending from the tube in the vertical direction;
a transmission positioned at a distal end of the tube, the transmission mechanically couplable to the power take off;
a first shaft coupled to the transmission, the first shaft extending from the distal end of the tube to a proximal end of the tube;
a second shaft coupled to the transmission, the second shaft extending from the distal end of the tube to the proximal end of the tube, the first shaft positioned within the second shaft, the second shaft independently rotatable around the first shaft;
an extruder block couplable to the proximal end of the tube, the extruder block defining a plurality of slots on a proximal surface; and
a cutter coupled to the first shaft at the proximal surface of the extruder block, the cutter rotatable by the first shaft.

2. The stand mixer of claim 1, further comprising a one-way bearing coupled to the first shaft, the one way bearing configured to lock and permit mated rotation of the first and second shaft in one direction of rotation.

3. The stand mixer of claim 1, wherein the second shaft of the pasta extruder attachment comprises an auger with a flighting configured for moving dough from the funnel to the proximal end of the tube and through the extruder block.

4. The stand mixer of claim 1, further comprising a cap configured to screw over the extruder block, securing the extruder block to the proximal end of the tube.

5. The stand mixer of claim 1, further comprising an outer ring positioned around the extruder block, the outer ring coupled to and rotatable by the first shaft.

6. The stand mixer of claim 5, wherein the cutter is coupled to an exterior edge of the outer ring, the cutter rotated with the rotation of the outer ring.

7. The stand mixer of claim 6, wherein the outer ring comprises an arm extending from the first shaft at the proximal end to the exterior edge of the outer ring.

8. The stand mixer of claim 1, wherein the cutter is one of a blade and a wire.

9. The stand mixer of claim 1, wherein the controller is in wireless communication with an external device over a network.

10. A pasta extruder attachment for a stand mixer, the stand mixer comprising a controller, the pasta extruder attachment comprising:
a casing defining a funnel and a tube, the funnel extending from the tube;
a transmission positioned at a distal end of the tube, the transmission mechanically couplable to the stand mixer;
a first shaft coupled to the transmission, the first shaft extending from the distal end of the tube to a proximal end of the tube;
a second shaft coupled to the transmission, the second shaft extending from the distal end of the tube to the proximal end of the tube, the second shaft comprising an auger, the first shaft positioned within the second shaft, the second shaft independently rotatable around the first shaft;
an extruder block couplable to the proximal end of the tube, the extruder block defining a plurality of slots on a proximal surface; and
a cutter coupled to the first shaft at the proximal surface of the extruder block, the cutter rotatable by the first shaft.

11. The pasta extruder attachment of claim 10, further comprising a one-way bearing coupled to the first shaft, the one way bearing configured to lock and permit mated rotation of the first and second shaft in one direction of rotation.

12. The pasta extruder attachment of claim 10, wherein the second shaft of the pasta extruder attachment comprises an auger with a flighting configured for moving dough from the funnel to the proximal end of the tube and through the extruder block.

13. The pasta extruder attachment of claim 10, further comprising a cap configured to screw over the extruder block, securing the extruder block to the proximal end of the tube.

14. The pasta extruder attachment of claim 10, further comprising an outer ring positioned around the extruder block, the outer ring coupled to and rotatable by the first shaft.

15. The pasta extruder attachment of claim 14, wherein the cutter is coupled to an exterior edge of the outer ring, the cutter rotated with the rotation of the outer ring.

16. The pasta extruder attachment of claim 15, wherein the outer ring comprises an arm extending from the first shaft at the proximal end to the exterior edge of the outer ring.

17. The pasta extruder attachment of claim 10, wherein the cutter is one of a blade and a wire.

18. The pasta extruder attachment of claim 10, wherein the controller is in wireless communication with an external device over a network.
